(19) United States
(12) Patent Application Publication
(10) Pub. No.: US 2015/0377757 A1
(43) Pub. Date: Dec. 31, 2015

(54) Small Two bar specimen (TBS)

(71) Applicant: Balhassn S. M. Ali, Cheverly, MD (US)

(72) Inventor: Balhassn S. M. Ali, Cheverly, MD (US)

(21) Appl. No.: 14/274,344

(22) Filed: Jun. 30, 2014

(51) Int. Cl. G01N 3/18

(52) U.S. Cl. CPC G01N 3/18

(57) ABSTRACT

This innovation is a new type of the small specimens, nun-destructive, creep testing techniques, which are used to obtain creep properties and the remaining life time of the critical high temperature engineering components; when only small amount of material is available for creep testing. The small Two bar specimen (TBS) is suitable for use to obtain both uniaxial creep strain and creep rupture life data, using small material samples. The specimen has a simple geometry and can be conveniently machined and loaded through pin-connections for testing. This innovation is also an efficient testing method to determine the material creep constants which are used in creep models. The small two bar specimen can be made from small material samples removed from the component surfaces and then creep tested. The specimen is loaded using two loading pins under high temperature until the rupture of the specimen. The specimen deformation is recorded throughout the test duration and then the specimen deformation is converted to the corresponding uniaxial date. The converted test result than can be used to obtain the creep strength and to determine the remaining life time for the components. For validation the P91 steel at 600° C. and the modified version of P91 (bar-257) steel at 650° C., were used to validate the small two bar specimen (TBS) testing method. Very good correlation is found between the test results obtained from the small two bar specimen creep tests and from the corresponding uniaxial creep tests specimen. The advantages of the TBS creep test specimen over other small specimens creep testing techniques are also discussed.

### 1. THE USE OF THE SMALL SPECIMENS CREEP TESTING

Many of the high temperature components such as, components in the traditional and in the nuclear power plants, chemical plants and oil refinery are operating at creep range. Many of these components are approaching the end of their design life. Therefore, creep strength for these components need to be carefully assessed on regular bases, in order to insure the safe operation of these critical engineering components. Typically a cylindrical uniaxial specimen with length approximately 130 mm and diameter of about 10 mm (see FIG. 1) is used to assess the creep strength [1]. This specimen type is the standard creep test specimen and this specimen type can obtain full creep strain time curves i.e. primary, secondary and tertiary creep regions, (see FIG. 2)[1]. In addition, the results of this specimen type are the reference to any other unconventional creep testing techniques.

However, in many of the high temperature components creep assessment situations; it is not possible to manufacture the uniaxial specimen, due to the limitation of the material available for testing. As an example, testing pressurized vessels, pipe bends and headers in the power plans, chemical plants or even in the oil refineries. These components normally assessed by removing small material samples from their surface, the small samples dominations approximately (2-3 mm) depth, (15-30 mm) length and (15-30 mm) width [1]. These small samples can be removed from differing components as they are in service, without effecting the safe operation of these components. These small samples then can be used to manufacture small specimens and then these specimens will be creep tested to give an indication of the creep strength and the remaining life time of these components.

### 2. THE LIMITATIONS OF THE TRADITIONAL, IN USE SMALL SPECIMEN CREEP TESTING METHODS

In the pest, many attempts have been made in order to determine the creep strength and the remaining life time for the high temperature components such as the impression and the small ring creep test. However, both testing techniques are limited to the secondary creep region; therefore theses testing techniques do not give any information about the tertiary region. The small punch creep test has been used as an attempt to obtain the full creep strain time curve. However, due to the complication associated with this testing method it has not been accepted and standardized worldwide. Some of these complications are (i) the large elastic and plastic deformation occur during the test, which make it very default to convert the small punch creep test results to the corresponding uniaxial data, (ii) increasing contact area between the specimen and the loading device during the test which make it very difficult to determine the corresponding uniaxial stress [1].

The sup size uniaxial specimen has been also used when the available material is limited, however this testing method is not accurate because of three reasons:—
I— due to the small specimen size the specimen ends have to be welded to the specimen for loading application, weld means changing the mechanical properties in and around the welded region specially in the soft heat affected zoon (HAZ) region, which mean the test result will not represent the actual creep strength for the component
II— The second issue is the alignment, welding small cylindrical bar from both ends and load it with good alignment in place is not straight forward task, and require sophisticated equipment for manufacturing and testing. In addition, machining and polishing small cylindrical specimen with good finishing is expensive and not an easy task [1].

### 3. BRIEF DESCRIPTION OF THE NATURE AND INTENDED USE OF THE TWO BAR SPECIMEN (TBS)

The newly invented small two bar specimen (TBS) see FIG. 4, can be used to obtain material creep strength and to determine the renaming life time for the high temperature components accurately [1]. The TBS can be manufactured using small material samples removed from the components surface or form critical welded regions such as welded metal (WM) or the heat affected zones (HAZ) of weld. The TBS can successfully replace the previous small specimens creep testing techniques, and also some of the other specimen which are used to assess creep strength for small material zones, such as the Cross-weld waisted specimen and the Cross-weld uniaxial specimen which are used to assess the creep strength for the HAZ region [1].

Unlike other small creep test specimens, the TBS can produce full creep strain time curves, i.e. the three creep regions, primary, secondary and tertiary, (see FIG. 2), with very good accuracy when compared with the corresponding uniaxial creep test data. The main advantages of the small two bar specimen (TBS) testing technique over the rest of the small specimens creep test techniques, can be summarised in the following points [1]:—

1—Unlike the impression creep test or the small ring creep test, the small two bar creep test specimen can be used to produce a full creep strain time curves identical to those obtained from the corresponding uniaxial creep tests results.
2—Unlike the sup-size uniaxial specimen where the two ends need to be welded for loading application, the two bar specimen (TBS) has the self-alignment properties as the specimen loaded through two loading pins, not through two fixed ends, in addition the specimen does not need to be welded at any stage of the testing.
3—Unlike the small punch creep test the elastic and the plastic deformation during the test is very limited
4—Unlike the small punch creep test where the specimen shape change significantly during the test; the TBS over all shape and dimensions does not change significantly during the test. Therefore, the small changes in the specimen dimensions have insignificant effects on the geometry dependent conversion factors β and η.
5—Compare to the sup-size uniaxial specimen the small TBS is easy to be manufactured and loaded.
6—The entire two bas specimen (TBS) can be made using limited volumes of material, therefore the TBS can be used to obtain the full creep strain time curves for the critical heat affected zones (HAZ) or weld metal (WM), for the first time.
7—Unlike the impression creep test where the indenter material has to be much higher creep resentence than the tested material, the TBS can be loaded using loading bin with similar creep resentence as the tested material.
8—The two bar specimen accurate results can significantly increase the efficiency and the accuracy of the high temperature components creep assessment operations.
9—Having accurate small specimen creep test technique such as the TBS allow engineers to increase the efficiency of the new power plants, by increasing the operating pressure and or temperature.

### 4. REFERENCE STRESS METHOD AND EQUIVALENT GAUGE LENGTH

### 4.1 Creep Deformation and Reference Stress Method (RSM)

For some components and loading modes, it is possible to obtain analytical expressions for the steady-state creep deformation rates, \dot{Δ}ₛₛ^{c}, [e.g. 1-3]. For a material obeying a Norton's power law, i.e. \dot{ε}=Bσⁿ, these show that the general form is:—

\dot{Δ}ₛₛ^{c}=f₁(n)f₂(dimensions)B(ασₙₒₘ)ⁿ (1)

where f₁ (n) is a function of the stress index, n, and f₂(dimensions) is a function of the component dimensions and σₙₒₘ is a conveniently determined nominal stress for the component and loading [3-5]. By introducing an appropriate scaling factor, α, for the nominal stress, Equ. (1) can be rewritten as:

$${\dot{Δ}}_{ss}^{c} = \frac{{f}_{1} ( n )}{{α}^{n}} {f}_{n} ( dimensions ) {B ( α {σ}_{nom} )}^{n} \qquad ( 2 )$$

By choosing several, random α values until the value of α(=η) so that the term

$$\frac{{f}_{1} ( n )}{{η}^{n}}$$

in Equ. (2), becomes independent (or approximately independent) of n, where n is the stress index in Norton's law, then Equ. (2) can be further simplified, i.e.

\dot{Δ}ₛₛ^{c}=D\dot{ε}(σ_{ref}) (3)

where D is the so-called reference multiplier, i.e.

$$D = \frac{{f}_{1} ( n )}{{η}^{n}} {f}_{2} ( dimensions )$$

and \dot{ε}c(σ_{ref}) is the minimum creep strain rate obtained from a uniaxial creep test at the so-called reference stress, i.e.

σ_{ref}=ησₙₒₘ (4)

The reference multiplier, D, has the units of length, and can usually be defined by D=βL, where L is a conveniently chosen, “characteristic”, component dimension. Therefore, for the known loading mode and component dimensions, σₙₒₘ can be conveniently defined, and if the values of η and β are known, the corresponding equivalent uniaxial stress can be obtained by Eq. (4), and the corresponding uniaxial minimum creep strain rate can be obtained using Eq. (3) if the minimum displacement rate is known [6, 7]

### 4.2 Equivalent Gauge Length (EGL)

For a conventional uniaxial creep test, the creep strain at a given time is usually determined from the deformation of the gauge length (GL). If the gauge length elongation is Δ and the elastic portion is neglected,

$${ɛ}^{c} = \frac{Δ}{GL} \qquad ( 5 a )$$

For non-conventional small specimen creep tests, an equivalent gauge length (EGL) can be defined, if the measured creep deformation can be related to an equivalent uniaxial creep strain [1], in the same form as that of Equ. (5a), i.e.

$${ɛ}^{c} = \frac{Δ}{EGL} \qquad ( 5 b )$$

The EGL is related to the dimensions of the tested specimen. The creep strain and creep deformation given in Equ. (5b) may be presented in a form related to the reference stress, (σ_{ref}.), i.e.

$${ɛ}^{c} ( {σ}_{ref} ) = \frac{{Δ}^{c}}{D} \qquad ( 6 )$$

in which D (=βL) is the reference multiplier, which is, in fact, the EGL for the test. In some cases, the geometric changes, due to the specimen creep deformation with time, are small (e.g. for impression creep tests), and in such cases, the effects of geometric changes on D (EGL) can be neglected [7].

### 4.3 Principle of the TBS Creep Testing Method

The TBS testing method is based on the principle of converting the TBS deformation and minimum deformation rate measured at the centre of the loading pin, to the corresponding uniaxial strain and minimum strain rate. The converted date then can be used to determine the component creep strength and the remaining life time. Conversion relationships are used to convert the TBS deformation to the corresponding uniaxial strain and to convert the TBS applied load to the corresponding uniaxial stress, i.e., equations 7 and 8.

$$\begin{matrix}\dot{ɛ} = \frac{\dot{Δ}}{EGL} & ( 7 ) \\ EGL = β \times {L}_{a} & \\ σ = η {σ}_{( nom )} & ( 8 ) \\ {σ}_{( nom )} = \frac{P}{bd} & ( 9 )\end{matrix}$$

where \dot{ε} is the equivalent uniaxial minimum creep strain rate, \dot{Δ}, is the TBS minimum deformation rate, Lₒ, is the distance between the centre of the two loading pins. β and η are the conversion factors which are specimen dimension ratio dependent, Lₒ, b, d are the TBS dimensions and EGL is the equivalent gage length and P is the applied load. the σ₍ₙₒₘ₎ is the nominal stress which is function of the applied load and the specimen dimensions.

Since the majority of the TBS dimensions, i.e. k, d and b, do not change significantly during the creep test duration (see table 1), the effects of the small geometry changes on the conversion factors β and η can be neglected. Therefore, the relationship presented in equation 7 can be used to convert the entire TBS creep deformation time curve to the creep strain time curve, i.e.

$$ɛ = \frac{Δ}{EGL} \qquad ( 10 )$$

where ε is the equivalent uniaxial creep strain, Δ, is the TBS deformation, EGL is the equivalent gauge length (βLₒ) for the TBS.

### 5. DETERMINING THE REFERENCE STRESS PARAMETERS

If an analytical solution for steady-state creep deformation rates can be obtained for components, substituting two values of n in the expression

$$\frac{{f}_{1} ( n )}{{η}^{n}}$$

and equating the two resulting expressions allow the value of 11 to be determined. Hence, σ_{ref}=(ησₙₒₘ), and D can be obtained as in Section 4.1. This approach was proposed by MacKenzie [1, 5]. However, analytical solutions for the component steady-state creep deformation rates only exist for a small number of relatively simple components and loadings [1]. If computed (e.g. finite element) solutions to a creep problem are obtained using several stress index n values, but keeping all other material properties, loading and component dimensions the same, then σ_{ref} and the conversion factors β and η can be obtained for the Two-bar specimen.

The conversion factors η and β for the TBS are obtained graphically as in FIG. 4. This can be done by running several finite elements (FE) creep analyse using Norton creep model, i.e. \dot{ε}^{c}=Aσⁿ, for a range of n values. The B and n in Norton's model are temperature dependent material constants. The TBS steady-state creep deformation rates between the two loading pins were obtained, for each of the n values. Several α values were considered for different n-values as shown in FIG. 4. The value of α which makes a horizontal line practically independent of n is the required a value. This a value (corresponding to the horizontal solid line in FIG. 4), is the conversion parameter, q, for the particular TBS geometry and dimensions. The value of β can then be obtained from the intercept of the horizontal, solid line in FIG. 4, with the vertical line, i.e.,

$$log ( \frac{2 {\dot{Δ}}_{ss}^{c}}{{L}_{O} {A ( α \frac{P}{0.5 bd} )}^{n}} ) .$$

This procedure explained in more details in ref.[1]

### 6. SUMMARY OF THE TBS TEST PROCEDURE

1. Small material samples are removed from the component surface or form the critical small regions such as the heat affected zones (HAZ) or from the weld metal (WM) of welded joints, these small material samples are used to manufacture the TBS.
2. Determine the conversion factors β and η, using finite element analyses method (FE) for the particular TBS dimensions.
3. The specimen normally is creep tested at the same operating temperature for the tested component and stress levels normally much higher than the operating stress; this is to make the specimen fail in a shorter times.
4. The specimen is loaded using a tensile loading P, the load magnitude is calculated for the required stress using Equation (8)
5. The TBS deformation is recorded throughout the test and then converted to the uniaxial minimum strain rate (MSR) and strain using Equations (7) and (10) respectively
6. These data than can be used to determine the creep strength for the components or the remaining life time also it can be used to determine the creep constants for any of creep models.

### 7. EXPERIMENTAL VALIDATION

In order to assess and demonstrate the accuracy of the TBS testing technique, a comparison between the TBS creep test results and the corresponding standard uniaxial creep test results have been carried out. The P91 steel grad (Bar-257), were used for the TBS validation. All tests were performed at a constant temperature of a 650° C., the tests were performed at stress levels of (70, 82, 87, 93 and 100 MPa), the creep deformation versus time curves obtained from the two bar specimens are shown in FIG. 5. The tested TBS dimensions were 13.0, 6.5, 2.0, 2.0 and 4.974 mm, for Lₒ, k, b, d and Dᵢ respectively. The η and β values, for the tested specimens, were 0.9966 and 1.4557, respectively. The converted TBS creep strain-time curves plotted together with the corresponding uniaxial creep strain-time curves in the FIG. 6. The converted TBS minimum creep strain rate and the failure times are compared with the corresponding uniaxial minimum creep strain rates and the failure times in FIG. 7 and FIG. 8.

The creep constants, which are used in the Norton's model, Kachanov model, i.e., equation 11 and Liu-Murakami model, i.e., equation 12, have been obtained, using the small TBS, for (Bar-257) P91 steel at 650° C. The results are compared in Table 2 with those obtained from the full size uniaxial specimens creep tests. Remarkably good agreement was found to exist between the two sets of results.

$$\begin{matrix}{ɛ}^{c} = \frac{B {σ}^{( n - χ )}}{{B}^{′} ( n - f - 1 )} ( {[ 1 - \frac{{B}^{′} ( 1 + f ) {σ}^{χ} {t}^{m + 1}}{m + 1} ]}^{\frac{f + 1 - n}{f + 1}} - 1 ) & ( 11 ) \\ Δ {ɛ}^{c} = B {σ}^{n} Exp [ \frac{2 ( n + 1 )}{π \sqrt{1 + 3 / n}} {ω}^{3 / 2} ] Δ t & ( 12 )\end{matrix}$$

in which Δt is the time increment, w is the damage parameter, where 0<ω<1. σ is the maximum principal stresses. B, n, B′, χ and m are material constants. The material constants can be obtained by curve fitting to the uniaxial creep curves [1].

Another version of The P91 steel were used in the validation of the TBS testing technique, this version is much stronger then the P91 grad (Bar-257). In general the P91 is used extensively in the high temperature applications such as in the power plant or chemical plants pipe works. Five tests were performed at a constant temperature of a 600° C., the tests were performed at stress levels of (140, 150, 160, 170 and 180 MPa), the creep deformation versus time curves obtained from the two bar specimens are shown in FIG. 9. The converted TBS creep strain time curves plotted together with the corresponding uniaxial strain time curves in the FIG. 10. The converted TBS minimum creep strain rate and the failure times are compared with the corresponding uniaxial minimum creep strain rates and the failure times in FIG. 11 and FIG. 12. Using the TBS results which are presented in FIGS. (9-12), the constants for the creep models, i.e., Norton's model, Equations (11 and 12) have been obtained. The results are compared with the corresponding results obtained from the uniaxial creep tests in table 3. Very good agreement is found between the two sets of results.

### DESCRIPTION OF THE FIGURES

FIG. 1 Standard uniaxial creep test specimen

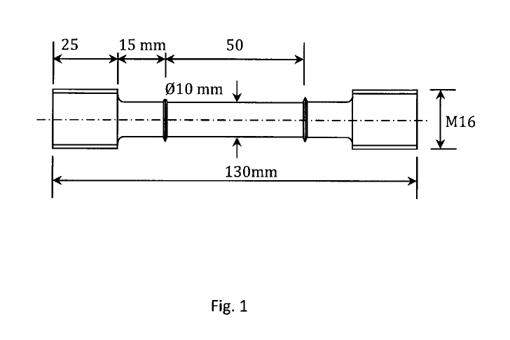

FIG. 2 A typical creep strain time curve, at constant stress and temperature

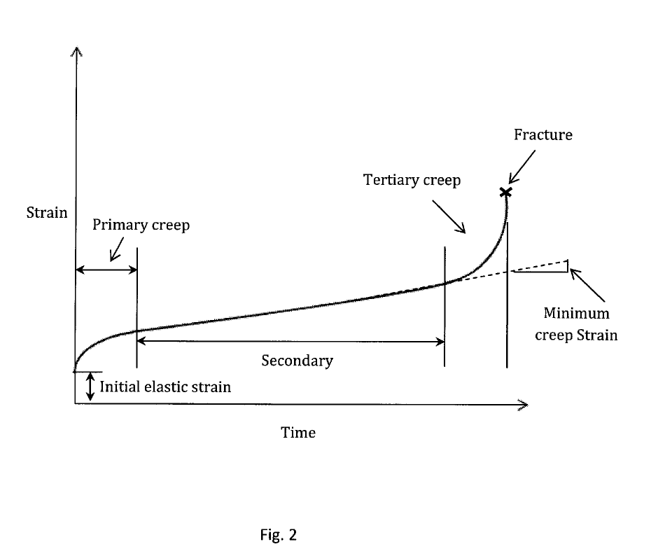

FIG. 3 The small Two bar specimen shape and dimensions, with the loading and concentrating pins in position, where Lₒ is the distance between the centres of the loading pins ^{˜}(6-13) mm, K is the supporting material behind the loading pins ^{˜}(3-7) mm, Dᵢ is the loading pin diameter ^{˜}(2-5) mm, b is the bar thickness ^{˜}(1-2) mm, d is the specimen depth ^{˜}(1-2) mm and P is the applied load.

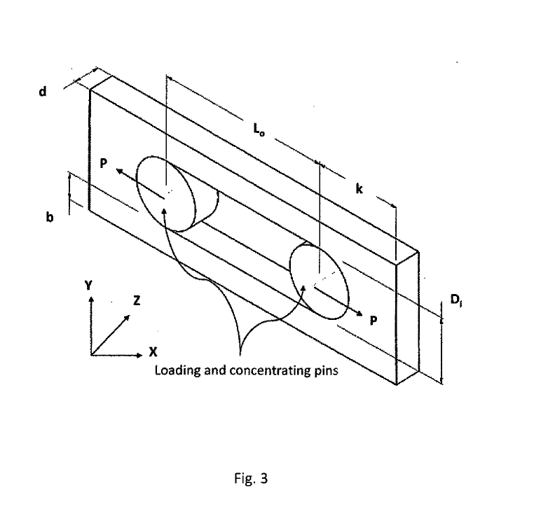

FIG. 4 Determination of β and η parameters for the TBS

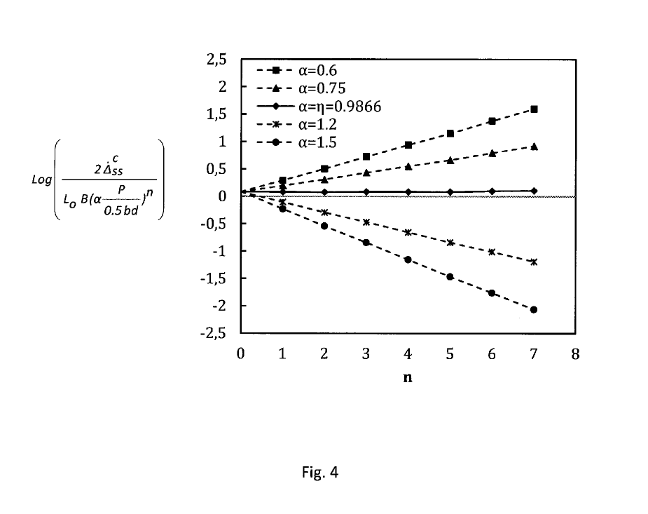

FIG. 5 The TBS Deformation times curves for P91 (Bar-257) steel at 650° C.

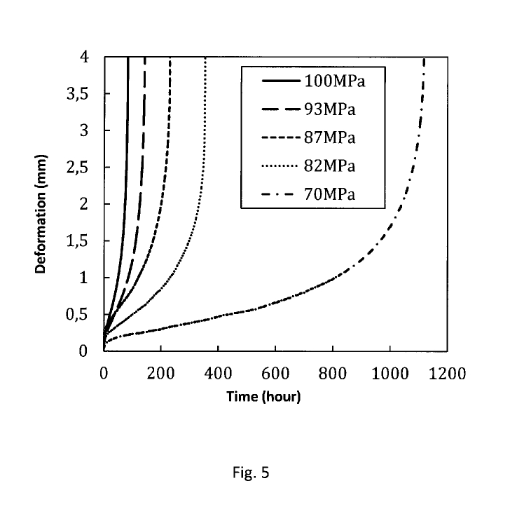

FIG. 6 Converted TBS creep strain curves together with the corresponding uniaxial creep strain curves for P91 (Bar-257) steel at 650° C., the stresses in [MPa]

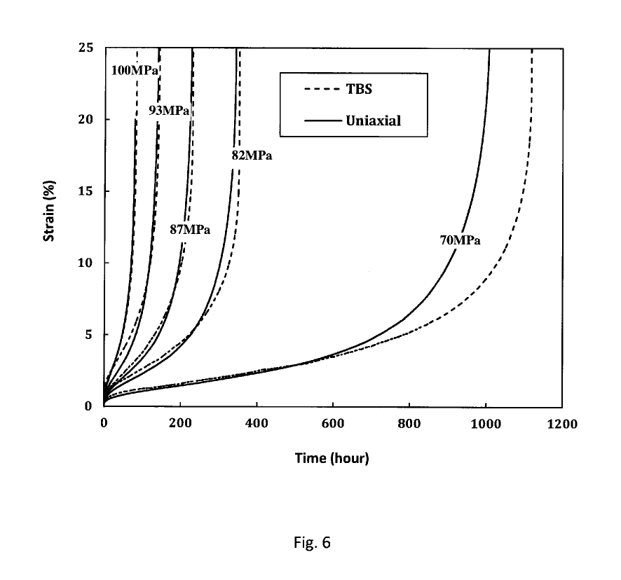

FIG. 7 Converted TBS and the corresponding uniaxial Minimum creep strain rate data for P91 (Bar-257) steel at 650° C.

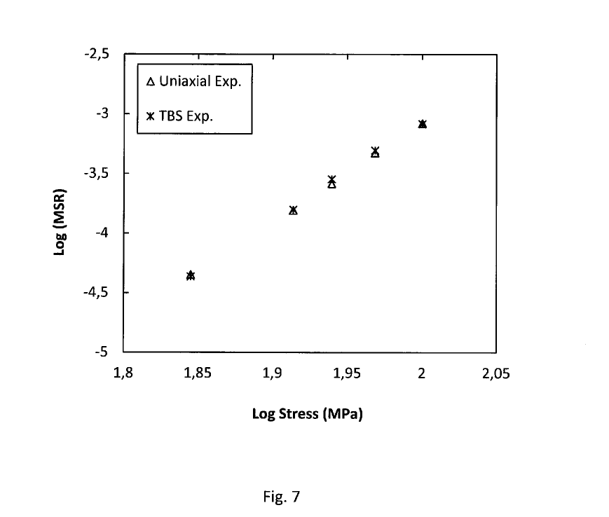

FIG. 8 The TBS creep failure times (t_{f}) and the corresponding uniaxial creep test failure times for P91 (Bar-257) steel at 650° C.

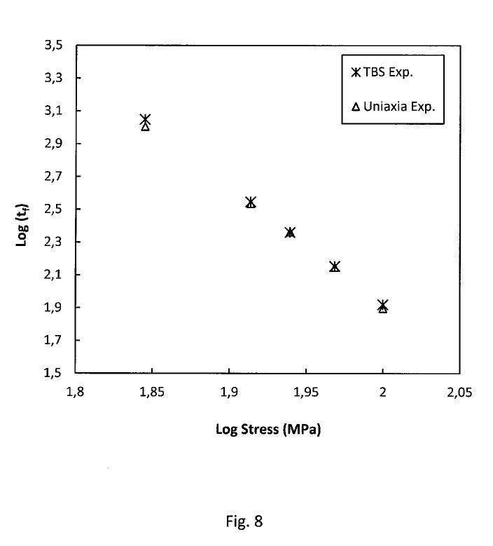

FIG. 9 The TBS Deformation-time curves for P91 steel at 600° C.

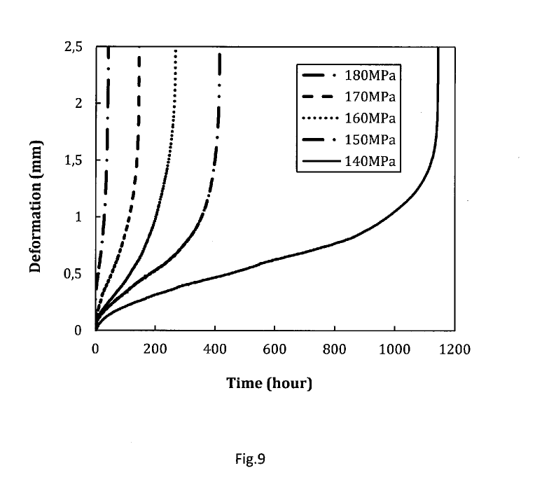

FIG. 10 Converted TBS creep strain-time curves together with the corresponding uniaxial creep strain-time curves for P91 steel at 600° C., the stresses in [MPa]

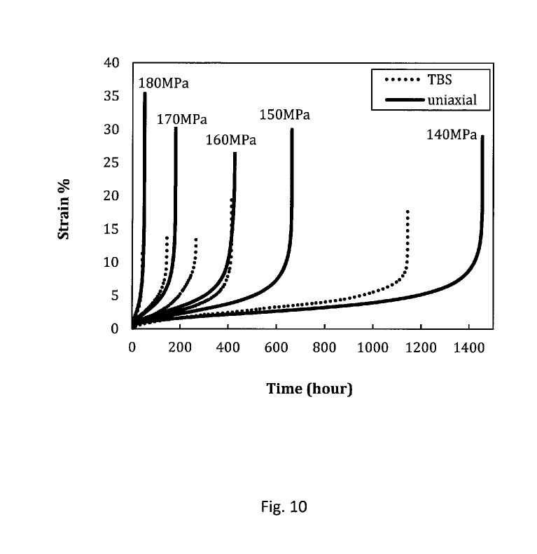

FIG. 11 Converted TBS and the corresponding uniaxial, minimum creep strain rate data, for P91 steel at 600° C.

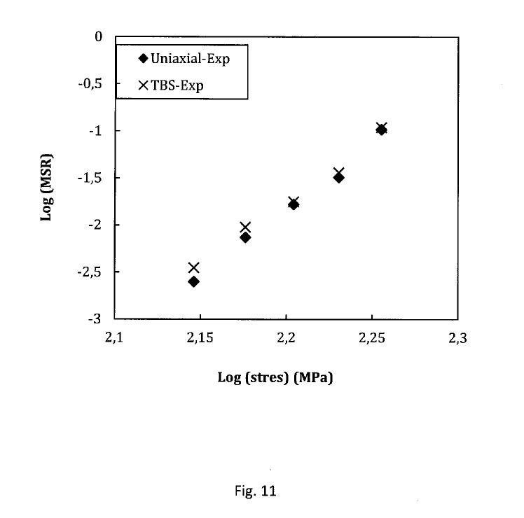

FIG. 12 The TBS creep failure times (t_{f}) and the corresponding uniaxial creep test failure times, for P91 steel at 600° C.

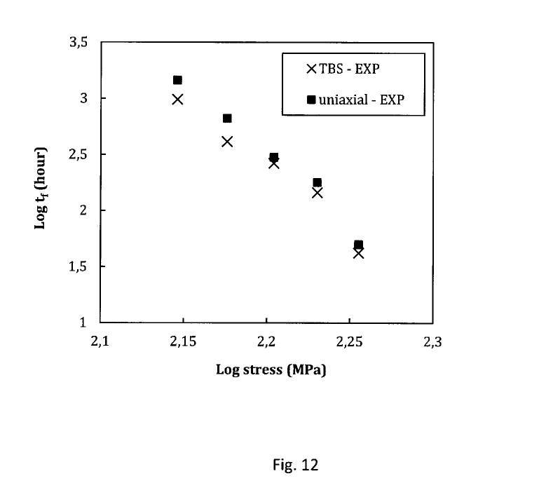

### DESCRIPTIONS OF THE TABLES

Table 1. The original dimensions of the tested TBS are Lₒ=13, d=2, b=2, k=6.5 and Dᵢ=5, all dimensions are in (mm), the specimens made of P91 (Bar-257) steel and tested at 650° C.

Table 2. Comparison between Creep material constants for the P91 (Bar-257) steel at 650° C., obtained using the uniaxial specimen and the small TBS

Table 3. Comparison between Creep material constants for the P91 steel at 600° C., obtained using the uniaxial specimen and the small TBS

### REFERENCE

1. Balhassn, S. M. Ali, 2014, Development of Non-Destructive Small Specimen Creep Testing Techniques, 225 pages, Thesis submitted to The University of Nottingham, Nottingham, UK.
2. Anderson R. G., Gardener L. R. T. and Hodgkins W. R., 1963, Deformation of uniformly loaded beams obeying complex creep laws, J. Mech. Eng. Sci. 5: 238-244,
3. Johnsson, A., 1973, An alternative definition of reference stress for creep, Int. J. Mech. Sci. 16 (5): 298-305.
4. Hyde T. H., Yehia K. and Sun W., 1996, Observation on the creep of two-material structures. J. Strain Analysis 31 (6): 441-461.
5. MacKenzie A. C., 1968, On the use of a single uniaxial test to estimate deformation rates in some structures undergoing creep. Int. J. Mech. Sci. 10: 44-453.
6. Balhassn S. M. Ali, Hyde, T. H. and Sun, W., Determination of material creep constants for damage models using a novel small two-bar specimen and the small notched specimen. ASME, Small Modular Reactors Symposium, 15-17 Apr. 2014. Washington D.C., USA.
7. Hyde, T. H., Ali, B. S. M., and Sun, W., 2013, Analysis and Design of a Small, Two-Bar Creep Test Specimen, J. Eng. Mater. Technol. 135(4)

TABLE 1

| Stress | Lₒ* | d* | b* | k* |
|---|---|---|---|---|
| 70 | 18.29 | 1.88 | 1.98 | 6.5 |
| 82 | 17.05 | 1.94 | 1.95 | 6.5 |
| 87 | 17.9 | 1.9 | 1.84 | 6.5 |
| 93 | 18.22 | 1.88 | 1.92 | 6.5 |
| 100 | 17.49 | 1.82 | 1.93 | 6.52 |
| Average | 17.79 | 1.88 | 1.92 | 6.50 |
| changes % | 26.92 | 6.15 | 3.95 | 0.06 |

TABLE 2

| Material | A | n | m | B | φ | χ | α | q₂ |
|---|---|---|---|---|---|---|---|---|
| uniaxial | 1.092 × 10⁻²⁰ | 8.462 | −4.754 × 10⁻⁴ | 3.537 × 10⁻¹⁷ | 7.346 | 6.789 | 0.312 | 3.2 |
| TBS | 1.0884 × 10⁻²⁰ | 8.455 | −3.5 × 10⁻⁴ | 3.052 × 10⁻¹⁸ | 9.5 | 7.276 | 0.37 | 4.00 |

α was obtained using the small notched specimen (the average of two tests) [1]

TABLE 3

| Material | A | n | B | φ | m | χ | α | q₂ |
|---|---|---|---|---|---|---|---|---|
| uniaxial | 1.00 × 10⁻³⁴ | 13.69 | 2.12 × 10⁻²⁷ | 18.00 | 0.00 | 10.96 | 0.3 | 6.00 |
| TBS | 9.5 × 10⁻³⁵ | 13.77 | 4.931 × 10⁻³⁰ | 19.00 | 0.00 | 11.64 | — | 7.00 |

1- The small two bar specimen designed to obtain the uniaxial creep data and to determine the remaining life time for the high temperature components, such as, components in the traditional and the nuclear power plants, chemical plants and oil refineries, using small material samples removed from these components.

2- The TBS is loaded using two loading pins, the loading pins are identical and opposite to each other, one is used to apply tensile load until the rupture of the specimen and the other one is to constrain the specimen.

3- The TBS deformation is recorded throughout the test and then converted to the equivalent uniaxial creep data, using conversion relationships and conversion factors, these conversion factors are specimen geometry dependent and can be obtained using the finite element analyses.
